(19) United States
(12) Patent Application Publication
(10) Pub. No.: US 2011/0192039 A1
(43) Pub. Date: Aug. 11, 2011

(54) Weight-reduced guide bar of solid material

(75) Inventors: Alexander Fuchs, Bietigheim-Bissingen (DE); Michael Leiter, Korb (DE)

(73) Assignee: Andreas Stihl AG & Co. KG

(21) Appl. No.: 12/929,642

(22) Filed: Feb. 7, 2011

(30) Foreign Application Priority Data
Feb. 6, 2010 (DE) 10 2010 007 081.5

(51) Int. Cl. B27B 17/02

(52) U.S. Cl. 30/383

(57) ABSTRACT

A guide bar (1) for the saw chain (2) of a motor-driven chain saw includes a longitudinal bar base body (3) of solid material having a reversal section (5) and a mounting section (8). A weight recess (11) is formed in a flat side (13) of the bar base body (3). The weight recess (11) extends essentially along the bar base body (3) and is closed by a cover plate (12). A light-weight, torsion-resistant guide bar is produced in that a longitudinal rib (14, 15) supporting the cover plate (12) is arranged in the weight recess (11) and extends in the longitudinal direction (19) of the guide bar (1).

### CROSS REFERENCE TO RELATED APPLICATION

This application claims priority of German patent application no. 10 2010 007 081.5, filed Feb. 6, 2010, the entire content of which is incorporated herein by reference.

### FIELD OF THE INVENTION

The invention relates to a guide bar for the saw chain of a motor-driven chain saw which includes an elongated bar base body made of solid material.

### BACKGROUND OF THE INVENTION

U.S. Pat. No. 4,794,696 discloses a solid-material guide bar whose base body has openings for weight reduction. These openings are closed by cover plates which lie flush on the corresponding flat sides of the guide bar base body. In order to ensure sufficient stability, the cover plates must be precisely adapted to, inserted in, and fixed to the countersinks of the openings. This involves high production costs.

### SUMMARY OF THE INVENTION

It is an object of the invention to develop a guide bar of solid material with weight recesses in such a manner that a simple and precise production with high stiffness of the guide bar is ensured.

The guide bar of the invention is for a saw chain of a motor driven chain saw. The guide bar includes: an elongated bar base body of solid material having a first end and a second end; a direction reversal section for the saw chain and the direction reversal section being arranged at the first end of the bar base body; a mounting section for fixating the guide bar and the mounting section being arranged at the second end; the bar base body defining an edge and having a flat side; a guide groove formed in the edge of the bar base body and being configured to guide the saw chain; a weight recess formed in the flat side of the bar base body and extending essentially along the bar base body between the mounting section and the reversal section; a cover plate for closing the weight recess; and, the weight recess having a longitudinal rib arranged therein for supporting the cover plate and the longitudinal rib extending in the longitudinal direction of the bar base body.

According to an embodiment of the invention, the weight recess opens to only one flat side of the guide bar base body, so that processing is required only on one side of the base body of the bar. The weight recess extends between the mounting section of the guide bar and the reversal section of the guide bar. A longitudinal rib, which supports a cover plate, is arranged in the weight recess. In this way, the cover plate is supported transversely to the longitudinal direction of the guide bar thereby ensuring high dimensional stability.

The longitudinal rib extends from one end of the weight recess to the other end of the weight recess and partitions the weight recess into component recesses. Thus, a plurality of recesses, which extend over the length of the guide bar base body, lie next to each other transversely to the longitudinal direction of the guide bar base body. This increases the connection stiffness of the weight-reduced guide bar of solid material.

The cover plate lies flush in a plane with the flat side of the guide bar base body. For this purpose, the cover plate is set in a countersink of the weight recess. The cover plate lies in the countersink in such a manner that its edge forms a gap with the peripheral edge of the weight recess. A connecting seam fixing the cover plate to the guide bar base body is accommodated in this gap. Preferably, this is done via a weld seam, in particular a bifocal laser weld seam. In this welding process two laser welding beams which are at a distance to each other are directed at the material and the edges (peripheral edge of the weight recess and the edge of the cover plate) are liquified so that the gap fills. Such a welding device is disclosed in DE 20 2004 017 854 U1.

In a further embodiment of the invention, the recess is ventilated, preferably through an intermittent weld seam.

The material of the cover plate is preferably hardened and tempered steel which preferably has the same or a higher carbon content than the guide bar base body. Expediently, the material of the cover plate has a degree of hardness of 20 to 58 HRC; a carbon content of 0.25% to 1% is advantageous. The material is especially 50CrMo4.

### BRIEF DESCRIPTION OF THE DRAWINGS

The invention will now be described with reference to the drawings wherein:

FIG. 1 is a perspective view of a guide bar of solid material with a weight recess and a corresponding cover plate; and,

FIG. 2 is a section view through a guide bar with a cover plate being fixed in the weight recess via a weld seam.

### DESCRIPTION OF THE PREFERRED EMBODIMENTS OF THE INVENTION

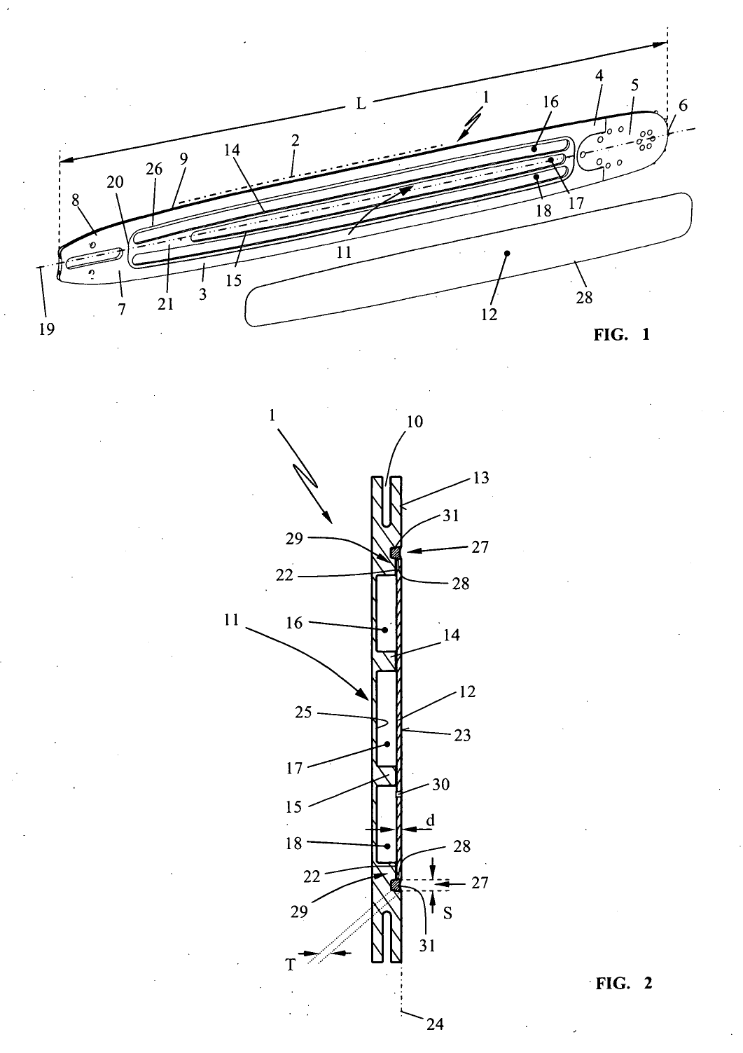

The guide bar 1 shown in FIG. 1 serves to guide a saw chain 2 on a motor-driven chain saw. The guide bar 1 includes an elongated guide bar base body 3 having the length L with a direction reversal section 5 for the saw chain 2 provided at one end 4. In the shown embodiment, the reversal section 5 is an attachment part with a rotatable sprocket nose 6 which engages between the links of the saw chain 2 and guides these in the area of the reversal section 5. The guide bar 1 can also be a one-part member.

At the other end 7 of the guide bar base body 3, a mounting section 8 is formed, which, in the shown embodiment, is provided as one piece with the guide bar base body 3.

The guide bar base body 3 has a guide groove 10 (FIG. 2) in its edge 9 in which guide sections of the saw chain 2 engage. In this way, the saw chain 2 is guided and held in the longitudinal direction of the guide bar 1 in the guide groove 10. The guide groove 10 continues in the reversal section 5 in the same manner as over a partial region of the mounting section 8.

The guide bar base body 3 is of solid material such as hardened and tempered steel, thus consisting of a one-part component. 50CrMo4 is preferably used as a material. This leads to a rigid and strong guide bar 1 which is provided with a weight recess 11 in order to reduce weight. The weight recess 11 essentially extends along the guide bar base body 3 between the mounting section 8 and the reversal section 5 over more than half the length of the guide bar base body 3. In the shown embodiment, the weight recess 11 essentially extends from the mounting section 8 to the reversal section 5.

The weight recess 11 is closed by a cover plate 12 which, as shown in FIG. 2, is fixed flush with a flat side 13 on the guide bar base body 3 in a countersink 22 of the flat side 13.

The weight recess 11 is a trough-like recess with a rectangular cross section and is open only toward one flat side 13 of the guide bar base body 3. In order to support the cover plate 12 over its width, at least one longitudinal rib 14 is provided in the weight recess 11. In the shown embodiment, two longitudinal ribs (14, 15) are provided in the weight recess 11. The two ribs (14, 15) essentially extend over the entire length of the weight recess 11 in the longitudinal direction 19 of the guide bar 1; thus, the weight recess is divided into a plurality of component recesses (16, 17, 18) extending in the longitudinal direction of the guide bar base body 3, so that a plurality of component recesses lie adjacent to each other transversely to the longitudinal direction of the guide bar base body 3. In the shown embodiment, three component recesses (16, 17, 18) are adjacent to each other.

As FIG. 1 shows, the component recesses 16 and 18 have approximately the same length and the same size while the component recess 17 formed between the longitudinal ribs 14 and 15 is shorter and smaller. The longitudinal ribs 14 and 15 merge before the end 20 of the weight recess 11 at the reversal section 8 into a joint support section 21. This is advantageous for force transmission in the area of the mounting section 8.

As FIG. 2 shows, the edge of the weight recess 11 is reduced by the thickness (d) of the cover plate 12, so that the cover plate 12 lies in a countersink 22 and the outer side 23 of the cover plate 12 and the flat side 13 of the guide bar base body 3 define a common plane 24. As FIG. 2 shows, the longitudinal ribs 14 and 15 vertically extend from the bottom 25 of the weight recess 11 to the cover plate 12, so that a support of the cover plate 12 is also ensured when force is applied from outside.

The edge 28 of the cover plate 12 is located in the countersink 22 of the guide bar base body 3 at a distance S from the peripheral edge 26 of the weight recess 11, so that there results a peripheral gap 27 between the edge 28 of the cover plate 12 and the peripheral edge 26 of the countersink 22. The supporting surface 29 of the cover plate 12 in the countersink 22 is larger transversely to the longitudinal direction 19 of the guide bar base body 3 than the width S of the gap 27, so that complete covering of the component recesses 16, 17 and 18 is invariably ensured independently of the position of the cover plate 12 in the countersink 22. The hollow spaces created by the weight recess 11 are ventilated; this can be provided by ventilating openings 30 or by a partially interrupted connecting seam 31 by which the cover plate 12 is fixed in the countersink 22 of the guide bar base body 3. The ventilation is preferably closed upon completion of the guide bar 1, for example, by a plug or the like.

As FIG. 2 shows, the connecting seam 31 fills the gap 27 almost completely. The connecting seam can be formed by hard soldering, adhesive bonding, welding, or the like. In a preferred embodiment, the connecting seam is produced by laser welding. Bifocal laser welding as disclosed in DE 20 2004 017 854 U1 is particularly suited for this. A good connection without warping can be produced by this method. The laser beams liquefy the peripheral edge 28 of the cover plate 12 as well as the edge 26 of the countersink 22, whereby the welding seam fills and/or bridges the peripheral gap 27. As FIG. 2 shows, a welding seam 31 forms in the gap 27 and is thicker than the depth of the countersink 22. The thickness T of the welding seam 31 preferably corresponds to about twice to three times the thickness (d) of the cover plate 12. The cover plate 12 has a thickness (d) of about 0.5 mm to 1 mm, preferably 0.75 mm.

The guide bar base body 3 is a high-quality hardened and tempered steel, preferably 50CrMo4. The cover plate 12 is made of steel having a degree of hardness of 20 to 58 HRC Rockwell hardness number; the material preferably has a carbon content in the range of 0.25% to 1%. In a further embodiment of the invention, the cover plate 12 is made of hardened and tempered steel which, according to the invention, has a higher carbon content than the guide bar base body 3. In particular, the cover plate 12 consists of a hardened and tempered steel 50CrMo4. It can be practical to design the cover plate of the same material as the guide bar base body.

It is understood that the foregoing description is that of the preferred embodiments of the invention and that various changes and modifications may be made thereto without departing from the spirit and scope of the invention as defined in the appended claims.

What is claimed is:

1. A guide bar for a saw chain of a motor driven chain saw, the guide bar comprising:
an elongated bar base body of solid material having a first end and a second end;
a direction reversal section for said saw chain and said direction reversal section being arranged at said first end of said bar base body;
a mounting section for fixating said guide bar and said mounting section being arranged at said second end;
said bar base body defining an edge and having a flat side;
a guide groove formed in said edge of said bar base body and being configured to guide said saw chain;
a weight recess formed in said flat side of said bar base body and extending essentially along said bar base body between said mounting section and said reversal section;
a cover plate for closing said weight recess; and,
said weight recess having a longitudinal rib arranged therein for supporting said cover plate and said longitudinal rib extending in the longitudinal direction of said bar base body.

2. The guide bar of claim 1, wherein said flat side is a first flat side and said bar base body has a second flat side; and, said weight recess opens to only one of said first and second flat sides of said bar base body.

3. The guide bar of claim 1, wherein said longitudinal rib partitions said weight recess into component recesses.

4. The guide bar of claim 3, wherein said weight recess is one of a plurality of weight recesses lying one next to the other transversely to the longitudinal direction of said bar base body.

5. The guide bar of claim 1, wherein said weight recess extends essentially from said mounting section to said reversal section.

6. The guide bar of claim 1, further comprising a countersink having a distance to said flat side of said bar base body; and, said longitudinal rib extending to said countersink.

7. The guide bar of claim 1, wherein said cover plate has an outer side lying in a plane with said flat side of said bar base body.

8. The guide bar of claim 1, wherein said cover plate has an edge; said weight recess has a peripheral edge; and, said edge of said cover plate and said peripheral edge of said weight recess conjointly define a gap.

9. The guide bar of claim 8, wherein said cover plate is fixed on said bar base body with a welding seam.

10. The guide bar of claim 1, wherein said welding seam is a bifocal laser welding seam.

11. The guide bar of claim 9, wherein said welding seam bridges said gap.

12. The guide bar of claim 9, wherein said welding seam fills said gap.

13. The guide bar of claim 1, wherein said weight recess is ventilated.

14. The guide bar of claim 8, wherein said welding seam is an intermittent welding seam; and, said weight recess is ventilated through said intermittent welding seam.

15. The guide bar of claim 1, wherein the material of said cover plate has a degree of hardness of 20 to 58 HRC.

16. The guide bar of claim 1, wherein the material of said cover plate has a carbon content between 0.25% and 1%.

17. The guide bar of claim 15, wherein the material of said cover plate is a hardened and tempered steel.

18. The guide bar of claim 16, wherein the material of said cover plate has a carbon content at least as high as the carbon content of said bar base body.

19. The guide bar of claim 15, wherein said cover plate consists essentially of 50CrMo4.

20. The guide bar of claim 1, wherein said flat side is a first flat side and said bar base body has a second flat side defining an uninterrupted surface devoid of any recesses.
